(19) United States
(12) Patent Application Publication
(10) Pub. No.: US 2024/0075907 A1
(43) Pub. Date: Mar. 7, 2024

(54) Vehicle Jacking Assembly

(71) Applicants: William Fisher, Austell, GA (US); Darrell Kelley, Austell, GA (US)

(72) Inventors: William Fisher, Austell, GA (US); Darrell Kelley, Austell, GA (US)

(21) Appl. No.: 17/901,029

(22) Filed: Sep. 1, 2022

(51) Int. Cl. B60S 9/12

(52) U.S. Cl. CPC B60S 9/12

(57) ABSTRACT

A vehicle jacking assembly for selectively raising a wheel of a vehicle for changing a tire includes a plurality of cylinders and an actuator. Each cylinder is configured to be coupled to a frame of a vehicle proximate to a respective wheel of the vehicle. The cylinder comprises a plurality of nested sections so that the cylinder is selectively extensible. The actuator is configured to be coupled to the vehicle and to be operationally coupled to an electrical circuit of the vehicle. The actuator is operationally coupled to the plurality of cylinders so that the actuator is positioned to selectively actuate a respective cylinder to extend the respective cylinder from the frame of the vehicle so that the respective cylinder contacts a surface. The respective cylinder thus is configured to raise an associated wheel of the vehicle from the surface, allowing a tire of the wheel to be changed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to jacking assemblies and more particularly pertain to a new jacking assembly for selectively raising a wheel of a vehicle for changing a tire.

### BRIEF SUMMARY OF THE INVENTION

An embodiment of the disclosure meets the needs presented above by generally comprising a plurality of cylinders and an actuator. Each cylinder is configured to be coupled to a frame of a vehicle proximate to a respective wheel of the vehicle. The cylinder comprises a plurality of nested sections so that the cylinder is selectively extensible. The actuator is configured to be coupled to the vehicle and to be operationally coupled to an electrical circuit of the vehicle. The actuator is operationally coupled to the plurality of cylinders so that the actuator is positioned to selectively actuate a respective cylinder to extend the respective cylinder from the frame of the vehicle so that the respective cylinder contacts a surface. The respective cylinder thus is configured to raise an associated wheel of the vehicle from the surface, allowing a tire of the wheel to be changed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a vehicle jacking assembly according to an embodiment of the disclosure.

FIG. 2 is a bottom view of an embodiment of the disclosure.

FIG. 3 is a front view of an embodiment of the disclosure.

FIG. 4 is a front view of an embodiment of the disclosure.

FIG. 5 is a block diagram of an embodiment of the disclosure.

### DETAILED DESCRIPTION OF THE INVENTION

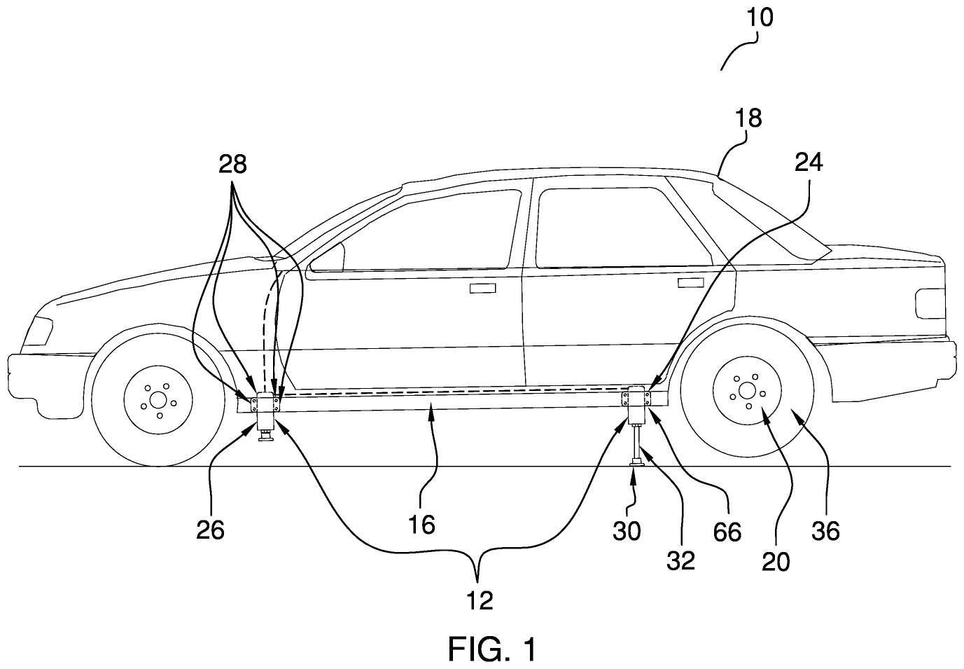

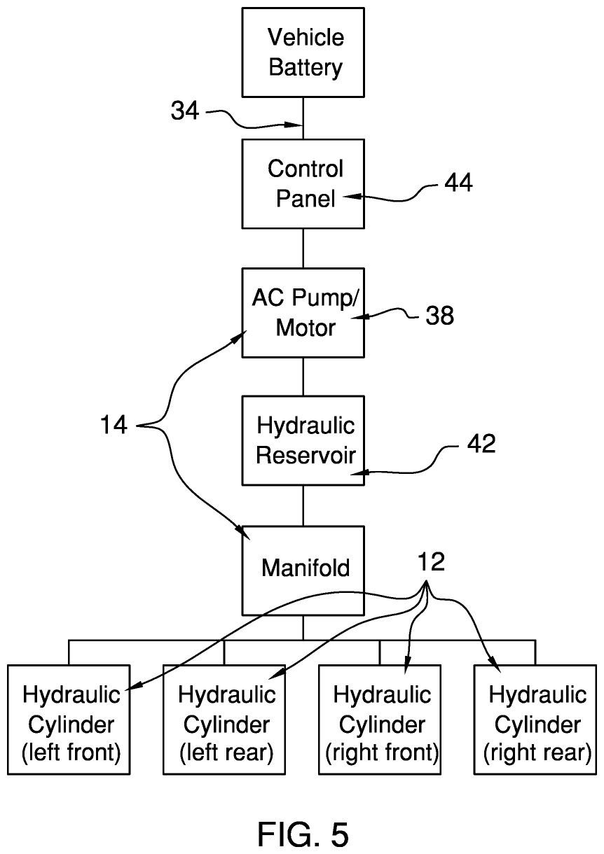

With reference now to the drawings, and in particular to FIGS. 1 through 5 thereof, a new jacking assembly embodying the principles and concepts of an embodiment of the disclosure and generally designated by the reference numeral 10 will be described.

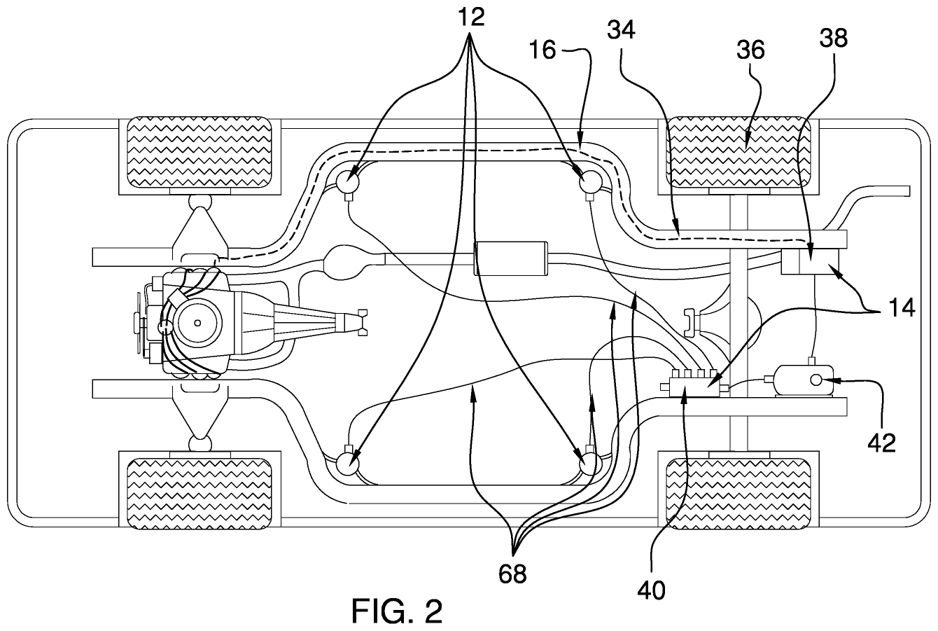

As best illustrated in FIGS. 1 through 5, the vehicle jacking assembly 10 generally comprises a plurality of cylinders 12 and an actuator 14. Each cylinder 12 is configured to be coupled to a frame 16 of a vehicle 18 proximate to a respective wheel 20 of the vehicle 18. The cylinder 12 comprises a plurality of nested sections 22 so that the cylinder 12 is selectively extensible. The plurality of cylinders 12 comprises four cylinders 12 so that each cylinder 12 is couplable to the frame 16 proximate to a respective wheel 20 of a four-wheeled vehicle, as shown in FIG. 2.

Each cylinder 12 comprises a first plate 24 that is coupled to an outermost nested section 26, as shown in FIG. 1. A plurality of holes 28 is positioned through the first plate 24. Each hole 28 is configured to insert an article of mounting hardware (not shown), such as a screw, bolt, or the like, to couple the first plate 24 to the frame 16 of the vehicle 18. The first plate 24 is substantially rectangularly shaped. The plurality of holes 28 comprises four holes 28 that are positioned singly proximate to each corner 66 of the first plate 24. The present invention also anticipates other methods of coupling the first plate 24 to the frame 16 of the vehicle 18, such as welding or the like.

A second plate 30 is coupled to an innermost nested section 32 so that the plurality of nested sections 22 extends perpendicularly from the second plate 30. The second plate 30 is configured to stabilize the cylinder 12 on a surface when the cylinder 12 is extended between the frame 16 of the vehicle 18 and the surface. The second plate 30 is circularly shaped.

The actuator 14 is configured to be coupled to the vehicle 18 and to be operationally coupled to an electrical circuit 34 of the vehicle 18. The actuator 14 is operationally coupled to the plurality of cylinders 12 so that the actuator 14 is positioned to selectively actuate a respective cylinder 12 to extend the respective cylinder 12 from the frame 16 of the vehicle 18 so that the respective cylinder 12 contacts a surface. The respective cylinder 12 thus is configured to raise an associated wheel 20 of the vehicle 18 from the surface, as shown in FIG. 1, allowing a tire 36 of the wheel 20 to be changed.

The actuator 14 comprises a hydraulic motor 38 and a manifold 40, as shown in FIG. 2. The manifold 40 is operationally coupled to the hydraulic motor 38 and to each of the cylinders 12 so that the manifold 40 is positioned to selectively direct hydraulic fluid from the hydraulic motor 38 to a respective cylinder 12 to extend the respective cylinder 12 from the frame 16 of the vehicle 18 so that the respective cylinder 12 contacts the surface. The respective cylinder 12 is configured to raise an associated wheel 20 of the vehicle 18 from the surface.

The assembly 10 also comprises a reservoir 42 that is configured to be coupled to the vehicle 18. The reservoir 42 is configured to position hydraulic fluid. The reservoir 42 is operationally coupled to the hydraulic motor 38 so that the reservoir 42 is in fluidic communication with the hydraulic motor 38. The reservoir 42 is configured to supply the hydraulic fluid to the hydraulic motor 38. Each hydraulic line 68 of a plurality of hydraulic lines 68 is operationally engaged to and extends between the manifold 40 and a respective cylinder 12.

A controller 44 is configured to be coupled to an interior surface of the vehicle 18. The controller 44 is operationally couplable to an electrical circuit of the vehicle 18. The controller 44 is operationally coupled to the actuator 14 so that the controller 44 is positioned to direct the actuator 14 to selectively actuate a respective cylinder 12 to extend the respective cylinder 12 from the frame 16 of the vehicle 18 so that the respective cylinder 12 contacts the surface to raise an associated wheel 20 of the vehicle 18 from the surface.

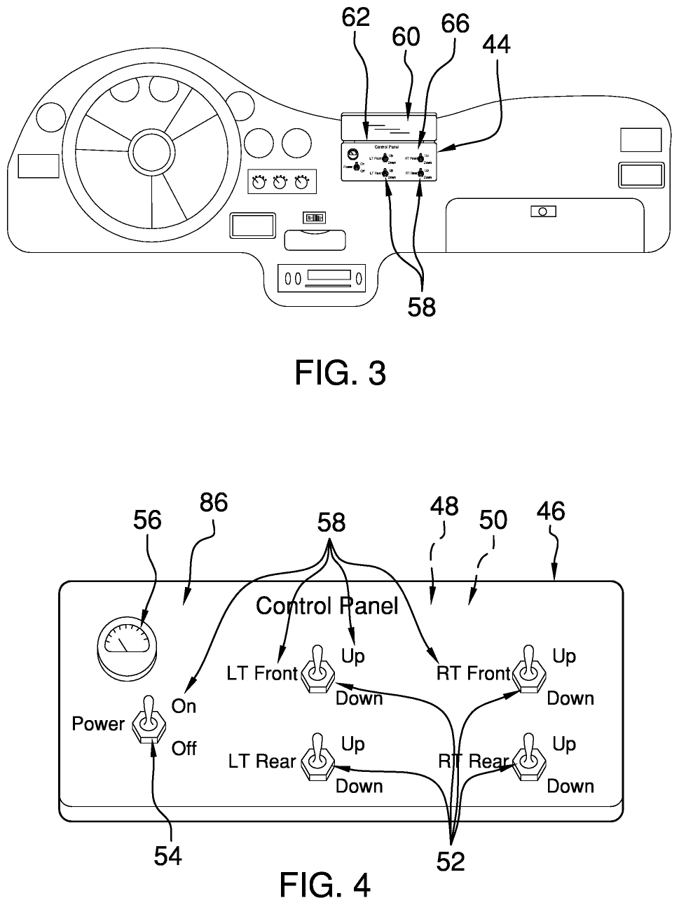

The controller 44 comprises a housing 46 that defines an interior space 48. A microprocessor 50 is coupled to the housing 46 and is positioned in the interior space 48. A plurality of switches 52, a power control 54, a gauge 56, and a plurality of indicia 58 are coupled to a front 64 of the housing 46, as shown in FIG. 3. The switches 52, the power control 54, and the gauge 56 are operationally coupled to the microprocessor 50. Each switch 52 is configured to be selectively switched to signal the microprocessor 50 to direct the actuator 14 to actuate an associated cylinder 12 to extend the associated cylinder 12 from the frame 16 of the vehicle 18 so that the associated cylinder 12 contacts the surface to raise an associated wheel 20 of the vehicle 18 from the surface. The power control 54 is configured to selectively activate the controller 44. The switches 52 are toggle-type and the power control 54 comprises a toggle switch.

The gauge 56 also is operationally coupled to the hydraulic motor 38. The gauge 56 is pressure type so that the gauge 56 is configured to measure and display a pressure of the hydraulic fluid.

The indicia 58 are configured to indicate a function and status of each of the switches 52 and the power control 54. For example, each switch 52 may be labeled as to its associated wheel 20 of the vehicle and have an “Up” and a “Down” notation corresponding to the status of the cylinder 12 associated with the associated wheel 20.

A panel 60 is hingedly coupled to an upper edge 62 of the front 64 of the housing 46, as shown in FIG. 3. The panel 60 is complementary to the front 64 of the housing 46 so that the panel 60 is positioned to be selectively hinged to cover the power control 54 and the plurality of switches 52. The panel 60 thus is configured to shield the power control 54 and the plurality of switches 52 from inadvertent activation.

The controller 44 is configured to be coupled to a dash of the vehicle 18, as shown in FIG. 3. The actuator 14 and the reservoir 42 are configured to be coupled to the frame 16 of the vehicle 18, as shown in FIG. 2. The present invention also anticipates the assembly 10 being integral to the vehicle 18, for example, by incorporation into the vehicle 18 during the manufacturing of the vehicle 18.

In use, when a tire 36 of a respective wheel 20 of a vehicle 18 needs to be changed, the user lifts the panel 60 to expose the front 64 of the controller 44. The power control 54 is switched on, and the switch 52 corresponding the respective wheel 20 is switched so that the microprocessor 50 directs the actuator 14 to actuate an associated cylinder 12 to extend the associated cylinder 12 from the frame 16 of the vehicle 18 so that the associated cylinder 12 contacts the surface to raise the respective wheel 20 of the vehicle 18 from the surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A vehicle jacking assembly comprising:
a plurality of cylinders, each cylinder being configured for coupling to a frame of a vehicle proximate to a respective wheel of the vehicle, the cylinder comprising a plurality of nested sections such that the cylinder is selectively extensible; and
an actuator configured for coupling to the vehicle and for operationally coupling to an electrical circuit of the vehicle, the actuator being operationally coupled to the plurality of cylinders such that the actuator is positioned for selectively actuating a respective cylinder for extending the respective cylinder from the frame of the vehicle such that the respective cylinder contacts a surface wherein the respective cylinder is configured for raising an associated wheel of the vehicle from the surface.

2. The assembly of claim 1, further including the plurality of cylinders comprising four cylinders such that each cylinder is couplable to the frame proximate to a respective wheel of a four-wheeled vehicle.

3. The assembly of claim 1, further including each cylinder comprising:
a first plate coupled to an outermost nested section;
a plurality of holes positioned through the first plate wherein each hole is configured for inserting an article of mounting hardware for coupling the first plate to the frame of the vehicle; and
a second plate coupled to an innermost nested section such that the plurality of nested sections extends perpendicularly from the second plate wherein the second plate is configured for stabilizing the cylinder on the surface when the cylinder is extended between the frame of the vehicle and the surface.

4. The assembly of claim 3, further including the first plate being substantially rectangularly shaped.

5. The assembly of claim 4, further including the plurality of holes comprising four holes positioned singly proximate to each corner of the first plate.

6. The assembly of claim 3, further including the second plate being circularly shaped.

7. The assembly of claim 1, further including the actuator comprising a hydraulic motor and a manifold, the manifold being operationally coupled to the hydraulic motor and to each of the cylinders such that the manifold is positioned for selectively directing hydraulic fluid from the hydraulic motor to a respective cylinder for extending the respective cylinder from the frame of the vehicle such that the respective cylinder contacts the surface wherein the respective cylinder is configured for raising an associated wheel of the vehicle from the surface.

8. The assembly of claim 7, further including a reservoir configured for coupling to the vehicle, the reservoir being configured for positioning hydraulic fluid, the reservoir being operationally coupled to the hydraulic motor such that the reservoir is in fluidic communication with the hydraulic motor wherein the reservoir is configured for supplying the hydraulic fluid to the hydraulic motor.

9. The assembly of claim 8, further including the actuator and the reservoir being configured for coupling to the frame of the vehicle.

10. The assembly of claim 7, further including a controller configured for coupling to an interior surface of the vehicle, the controller being operationally couplable to an electrical circuit of the vehicle, the controller being operationally coupled to the actuator such that the controller is positioned for directing the actuator for selectively actuating a respective cylinder for extending the respective cylinder from the frame of the vehicle such that the respective cylinder contacts the surface for raising an associated wheel of the vehicle from the surface.

11. The assembly of claim 10, further including the controller being configured for coupling to a dash of the vehicle.

12. The assembly of claim 10, further including the controller comprising:
a housing defining an interior space;
a microprocessor coupled to the housing and positioned in the interior space;
a plurality of switches coupled to a front of the housing, the switches being operationally coupled to the microprocessor wherein each switch is configured for selectively switching for signaling the microprocessor for directing the actuator for actuating an associated cylinder for extending the associated cylinder from the frame of the vehicle such that the associated cylinder contacts the surface for raising an associated wheel of the vehicle from the surface; and
a power control coupled to the front of the housing, the power control being operationally coupled to the microprocessor wherein the power control is configured for selectively activating the controller.

13. The assembly of claim 12, further comprising:
the switches being toggle-type; and
the power control comprising a toggle switch.

14. The assembly of claim 12, further including a gauge coupled to the front of the housing, the gauge being operationally coupled to the microprocessor and the hydraulic motor, the gauge being pressure type wherein the gauge is configured for measuring and displaying a pressure of the hydraulic fluid.

15. The assembly of claim 12, further including a plurality of indicia coupled to the front of the housing wherein the indicia are configured for indicating a function and status of each of the switches and the power control.

16. The assembly of claim 12, further including a panel hingedly coupled to an upper edge of the front of the housing, the panel being complementary to the front of the housing such that the panel is positioned for selectively hinging for covering the power control and the plurality of switches wherein the panel is configured for shielding the power control and the plurality of switches from inadvertent activation.

17. A vehicle and vehicle jacking assembly combination comprising:
a vehicle;
a plurality of cylinders, each cylinder being coupled a frame of the vehicle proximate to a respective wheel of the vehicle, the cylinder comprising a plurality of nested sections such that the cylinder is selectively extensible; and
an actuator coupled to the vehicle and operationally coupled to an electrical circuit of the vehicle, the actuator being operationally coupled to the plurality of cylinders such that the actuator is positioned for selectively actuating a respective cylinder for extending the respective cylinder from the frame of the vehicle such that the respective cylinder contacts a surface wherein the respective cylinder is configured for raising an associated wheel of the vehicle from the surface.

18. A vehicle jacking assembly comprising:
a plurality of cylinders, each cylinder being configured for coupling to a frame of a vehicle proximate to a respective wheel of the vehicle, the cylinder comprising a plurality of nested sections such that the cylinder is selectively extensible, the plurality of cylinders comprising four cylinders such that each cylinder is couplable to the frame proximate to a respective wheel of a four-wheeled vehicle, each cylinder comprising:
a first plate coupled to an outermost nested section,
a plurality of holes positioned through the first plate wherein each hole is configured for inserting an article of mounting hardware for coupling the first plate to the frame of the vehicle, the first plate being substantially rectangularly shaped, the plurality of holes comprising four holes positioned singly proximate to each corner of the first plate, and
a second plate coupled to an innermost nested section such that the plurality of nested sections extends perpendicularly from the second plate wherein the second plate is configured for stabilizing the cylinder on a surface when the cylinder is extended between the frame of the vehicle and the surface, the second plate being circularly shaped;
an actuator configured for coupling to the vehicle and for operationally coupling to an electrical circuit of the vehicle, the actuator being operationally coupled to the plurality of cylinders such that the actuator is positioned for selectively actuating a respective cylinder for extending the respective cylinder from the frame of the vehicle such that the respective cylinder contacts the surface wherein the respective cylinder is configured for raising an associated wheel of the vehicle from the surface, the actuator comprising a hydraulic motor and a manifold, the manifold being operationally coupled to the hydraulic motor and to each of the cylinders such that the manifold is positioned for selectively directing hydraulic fluid from the hydraulic motor to a respective cylinder for extending the respective cylinder from the frame of the vehicle such that the respective cylinder contacts the surface wherein the respective cylinder is configured for raising an associated wheel of the vehicle from the surface, the actuator being configured for coupling to the frame of the vehicle;
a reservoir configured for coupling to the vehicle, the reservoir being configured for positioning hydraulic fluid, the reservoir being operationally coupled to the hydraulic motor such that the reservoir is in fluidic communication with the hydraulic motor wherein the reservoir is configured for supplying the hydraulic fluid to the hydraulic motor, the reservoir being configured for coupling to the frame of the vehicle; and
a controller configured for coupling to an interior surface of the vehicle, the controller being operationally couplable to an electrical circuit of the vehicle, the controller being operationally coupled to the actuator such that the controller is positioned for directing the actuator for selectively actuating a respective cylinder for extending the respective cylinder from the frame of the vehicle such that the respective cylinder contacts the surface for raising an associated wheel of the vehicle from the surface, the controller being configured for coupling to a dash of the vehicle, the controller comprising:
a housing defining an interior space,
a microprocessor coupled to the housing and positioned in the interior space,
a plurality of switches coupled to a front of the housing, the switches being operationally coupled to the microprocessor wherein each switch is configured for selectively switching for signaling the microprocessor for directing the actuator for actuating an associated cylinder for extending the associated cylinder from the frame of the vehicle such that the associated cylinder contacts the surface for raising an associated wheel of the vehicle from the surface, the switches being toggle-type,
a power control coupled to the front of the housing, the power control being operationally coupled to the microprocessor wherein the power control is configured for selectively activating the controller, the power control comprising a toggle switch,
a gauge coupled to the front of the housing, the gauge being operationally coupled to the microprocessor and the hydraulic motor, the gauge being pressure type wherein the gauge is configured for measuring and displaying a pressure of the hydraulic fluid,
a plurality of indicia coupled to the front of the housing wherein the indicia are configured for indicating a function and status of each of the switches and the power control, and
a panel hingedly coupled to an upper edge of the front of the housing, the panel being complementary to the front of the housing such that the panel is positioned for selectively hinging for covering the power control and the plurality of switches wherein the panel is configured for shielding the power control and the plurality of switches from inadvertent activation.
